(19) United States
(12) Patent Application Publication
(10) Pub. No.: US 2020/0324901 A1
(43) Pub. Date: Oct. 15, 2020

(54) CONTROL METHOD FOR UNMANNED AERIAL VEHICLE, FLIGHT CONTROLLER AND UNMANNED AERIAL VEHICLE

(71) Applicant: SZ DJI TECHNOLOGY CO., LTD., Shenzhen (CN)

(72) Inventors: Chang GENG, Shenzhen (CN); Canlong LIN, Shenzhen (CN)

(21) Appl. No.: 16/915,300

(22) Filed: Jun. 29, 2020

Related U.S. Application Data
(63) Continuation of application No. PCT/CN2017/120185, filed on Dec. 29, 2017.

(51) Int. Cl. B64C 39/02; G05D 1/00; G05D 1/10

(52) U.S. Cl. CPC B64C 39/024; B64C 2201/146; G05D 1/101; G05D 1/0011

(57) ABSTRACT

A control method for an unmanned aerial vehicle (UAV) includes obtaining location information of the UAV and location information of a flight restriction area, obtaining a flight mode of the UAV in response to determining that the UAV enters a buffer area of the flight restriction zone according to the location information of the UAV and the location information of the flight restriction zone, in response to the flight mode of the UAV being a non-velocity-control mode, switching the flight mode of the UAV from the non-velocity-control mode to a velocity-control mode, and controlling a velocity of the UAV according to the location information of the flight restriction zone.

### CROSS-REFERENCE TO RELATED APPLICATION

This application is a continuation of International Application No. PCT/CN2017/120185, filed Dec. 29, 2017, the entire content of which is incorporated herein by reference.

### TECHNICAL FIELD

The present disclosure relates to the field of unmanned aerial vehicles (UAVs) and, more particularly, to a control method of UAVs, a flight controller and a UAV.

### BACKGROUND

At present, UAVs can be applied in many fields, such as crop and plant protection, surveying and mapping, electric power inspection, disaster relief and other fields.

However, the UAVs may be restricted in some areas or regions, that is, the UAVs are restricted from flying to a flight restriction zone. Therefore, a method that can effectively control the UAV to prevent the UAV from flying into the flight restriction zone is needed.

### SUMMARY

In accordance with the disclosure, there is provided a control method for an unmanned aerial vehicle (UAV) including obtaining location information of the UAV and location information of a flight restriction area, obtaining a flight mode of the UAV in response to determining that the UAV enters a buffer area of the flight restriction zone according to the location information of the UAV and the location information of the flight restriction zone, in response to the flight mode of the UAV being a non-velocity-control mode, switching the flight mode of the UAV from the non-velocity-control mode to a velocity-control mode, and controlling a velocity of the UAV according to the location information of the flight restriction zone.

Also in accordance with the disclosure, there is provided a flight controller of an unmanned aerial vehicle (UAV) including a memory storing a program and a processor configured to execute the program to obtain location information of the UAV and location information of a flight restriction area, obtain a flight mode of the UAV in response to determining that the UAV enters a buffer area of the flight restriction zone according to the location information of the UAV and the location information of the flight restriction zone, in response to the flight mode of the UAV being a non-velocity-control mode, switch the flight mode of the UAV from the non-velocity-control mode to a velocity-control mode, and control a velocity of the UAV according to the location information of the flight restriction zone.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts.

FIG. 1 is a schematic flow chart of a control method for an unmanned aerial vehicle (UAV) according to an embodiment of the present disclosure.

FIG. 2 is a schematic diagram of a communication system according to an embodiment of the present disclosure.

FIG. 3 is a schematic diagram of an application scenario of the control method for the UAV according to an embodiment of the present disclosure.

FIG. 4 is a schematic diagram of an application scenario of the control method for the UAV according to another embodiment of the present disclosure.

FIG. 5 is a schematic diagram of an application scenario of the control method for the UAV according to another embodiment of the present disclosure.

FIG. 6 is a schematic flow chart of a control method for a UAV according to another embodiment of the present disclosure.

FIG. 7 is a schematic diagram of an application scenario of the control method for the UAV according to another embodiment of the present disclosure.

FIG. 8 is a structural diagram of a flight controller according to an embodiment of the present disclosure.

FIG. 9 is a structural diagram of a UAV according to an embodiment of the present disclosure.

### REFERENCE NUMERALS

20—Unmanned Aerial Vehicle, 21—Ground terminal, 22—Flight Controller, 23—Communication System, 24—Antenna, 80—Flight Controller, 81—Memory, 82—Processor, 100—Unmanned Aerial Vehicle, 107—Motor, 106—Propeller, 117—Electronic Governor, 118—Flight Controller, 108—Sensor System, 110—Communication System, 102—Support Device, 104—Photographing Device, 112—Ground Station, 114—Antenna, 116—Electromagnetic Wave.

### DETAILED DESCRIPTION OF THE EMBODIMENTS

The technical solutions in the example embodiments of the present disclosure will be described clearly and completely with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

The embodiments of the present disclosure will be described in detail with reference to the accompanying drawings. In the case of no conflict, the following embodiments and the features in the embodiments can be combined with each other.

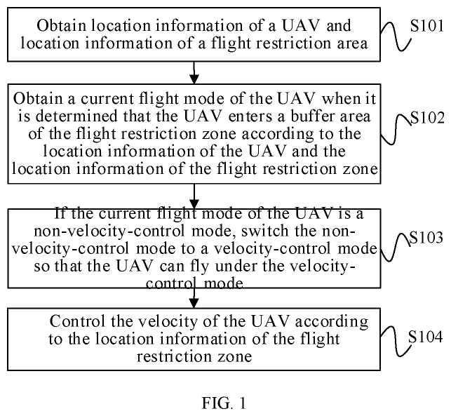

A control method for UAV is provided according to an embodiment of the present disclosure. FIG. 1 is a flow chart of the control method for the UAV provided by an embodiment of the present disclosure. As shown in FIG. 1, at S101, location information of the UAV and location information of a flight restriction area are obtained.

The executive subject of the method of this embodiment may be a flight control device, and the flight control device may be a control device that performs flight control on the UAV. Specifically, the flight control device may be a flight controller of the UAV.

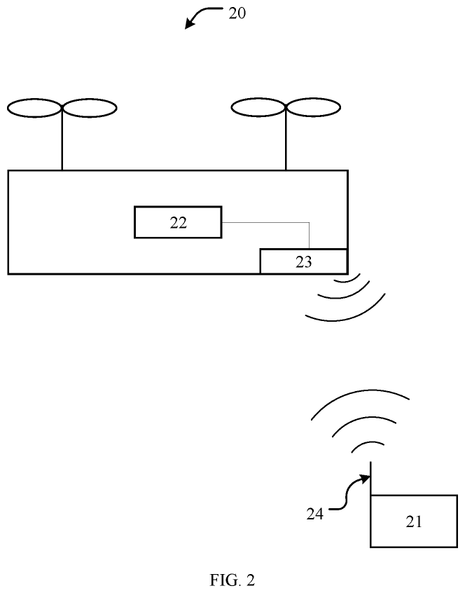

As shown in FIG. 2, the UAV 20 can perform wireless communication with the corresponding ground terminal 21. The ground terminal 21 can specifically be a remote controller, an intelligent terminal, or other devices. The UAV 20 includes a flight controller 22 and a communication system 23. The communication system 23 may specifically include a receiver for receiving the wireless signal sent by the antenna 24 of the ground terminal 21.

The UAV 20 may also be provided with a positioning device such as a Global Positioning System (GPS) positioning device, and the flight controller 22 may obtain location information of the UAV 20 through the GPS positioning device. In addition, some areas or regions may restrict the UAV flight, that is, the UAV may be restricted from flying to the flight restriction zone. The UAV 20 may also prestore location information of the flight restriction zone, and the flight controller 22 may obtain the location information of the flight restriction zone prestored in the UAV 20.

At S102, when it is determined that the UAV enters a buffer area of the flight restriction zone according to the location information of the UAV and the location information of the flight restriction zone, a current flight mode of the UAV is obtained.

Specifically, the flight controller 22 can determine the buffer area of the flight restriction zone according to the location information of the UAV 20 and the location information of the flight restriction zone. Further, the flight controller 22 can determine whether the UAV 20 enters the buffer area of the flight restriction zone according to the location information of the UAV 20.

When the flight controller 22 determines that the UAV 20 enters the buffer area of the flight restriction zone, the current flight mode of the UAV 20 is obtained.

In some embodiments, the flight modes of the UAV include a first mode for controlling the angular velocity of the UAV such as a manual mode, a second mode for controlling the attitude of the UAV such as an attitude mode, and a third mode for controlling the velocity of the UAV. In some embodiments, the third mode may be a position mode where the user manually controls the velocity of the UAV or may be an autonomous flight mode of the UAV.

In addition, the method further includes controlling the UAV to hover when it is determined that the UAV enters the buffer area of the flight restriction zone. For example, when the flight controller 22 determines that the UAV 20 enters the buffer area of the flight restriction zone, it can also control the UAV 20 to hover.

In other embodiments, when it is determined that the UAV enters the flight restriction zone according to the location information of the UAV, the UAV is controlled to descend. For example, when the flight controller 22 determines that the UAV 20 enters the flight restriction zone according to the location information of the UAV 20, the UAV 20 can be controlled to descend directly to prevent the UAV from staying in the flight restriction zone for a long time.

At S103, if the current flight mode of the UAV is a non-velocity-control mode, the non-velocity-control mode is switched to a velocity-control mode, so that the UAV can fly under the velocity-control mode.

After the flight controller 22 obtains the current flight mode of the UAV 20, it further determines whether the current flight mode of the UAV 20 is a non-velocity-control mode. If the current flight mode of the UAV 20 is non-velocity-control mode, the non-velocity-control mode is switched to the velocity-control mode so that the UAV 20 can fly under the velocity-control mode.

In some embodiments, the non-velocity-control mode refers to a mode other than the velocity-control mode, and includes at least one of the first mode for controlling the angular velocity of the UAV and the second mode for controlling the attitude of the UAV. In some embodiments, the velocity-control mode includes the third mode for controlling the velocity of the UAV.

For example, if the current flight mode of the UAV 20 is the first mode such as the manual mode, when the UAV 20 enters the buffer area of the flight restriction zone, the flight controller 22 may switch the current manual mode of the UAV 20 to the position mode for controlling the velocity of the UAV. If the current flight mode of the UAV 20 is the second mode such as the attitude mode, when the UAV 20 enters the buffer area of the flight restriction zone, the flight controller 22 may switch the current attitude mode of the UAV 20 to the position mode for controlling the velocity of the UAV. Therefore, the UAV 20 can fly according to the position mode after entering the buffer area of the flight restriction zone.

In some embodiments, after switching the non-velocity-control mode to the velocity-control mode, a control command for controlling the UAV is obtained. If the component of the control vector indicated by the control command includes a component pointing to the flight restriction zone, the control command is not executed.

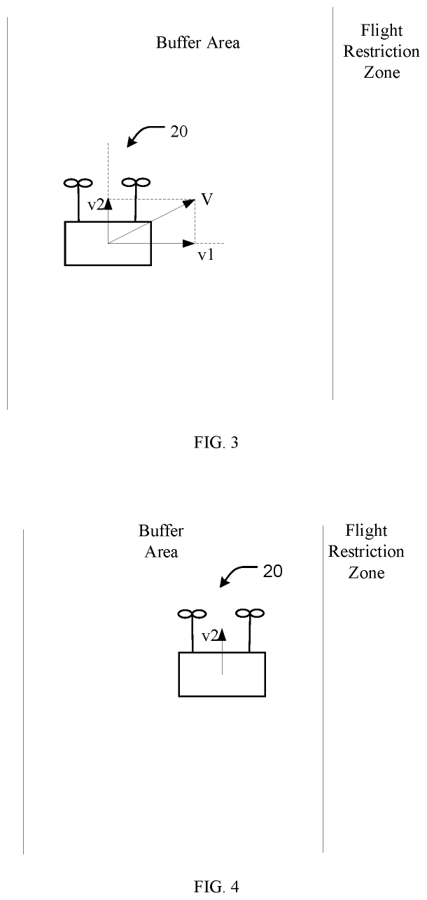

For example, the current flight mode of the UAV 20 is the first mode such as the manual mode. When the UAV 20 enters the buffer area of the flight restriction zone, the flight controller 22 may switch the current manual mode of the UAV 20 to the position mode for controlling the velocity of the UAV. At this moment, when a user operates the ground terminal 21, such as the joystick or keys of the remote controller, the remote controller generates a control command. The control command may specifically be the joystick value used to control the velocity of the UAV 20. The joystick value may refer to, e.g., an amount of deviation of the joystick from a neutral position. The remote controller sends the joystick value to the UAV 20, and the flight controller 22 receives the joystick value through the communication system 23 of the UAV 20. As shown in FIG. 3, V represents a velocity vector indicated by the joystick value for controlling the velocity of the UAV 20. The velocity vector V can be decomposed into two components perpendicular to each other, such as component v1 and component v2. As shown in FIG. 3, the component v1 points to the flight restriction zone, that is, the velocity vector V includes the component v1 pointing to the flight restriction zone. If the edge of the flight restriction zone is perpendicular to the ground, then the component v1 may be a horizontal component. If the flight controller 22 controls the velocity of the UAV 20 according to the velocity vector V, it will cause the UAV 20 to enter the flight restriction zone. In order to prevent the UAV 20 from entering the flight restriction zone, when the flight controller 22 detects that the velocity vector V indicated by the control command, which is sent by the ground terminal 21, includes a component pointing to the flight restriction zone, the control command is not executed or the control command is not responded to, thereby the UAV 20 is prevented from entering the flight restriction zone.

In some other embodiments, after switching the non-velocity-control mode to the velocity-control mode, a control command for controlling the UAV is obtained. If the component of the control vector indicated by the control command includes a component pointing to the flight restriction zone, the component pointing to the flight restriction zone is removed from the components of the control vector. The UAV is controlled according to the control command after removing the component pointing to the flight restriction zone.

As shown in FIG. 3, V represents a velocity vector indicated by the joystick value for controlling the velocity of the UAV 20. The velocity vector V can be decomposed into two components perpendicular to each other, such as component v1 and component v2. As shown in FIG. 3, the component v1 points to the flight restriction zone. At this moment, the flight controller 22 may remove the component v1 from the velocity vector V, and keep the other components, namely the component v2. In addition, the velocity vector V is not limited to being decomposed into component v1 and component v2, but can also be decomposed into multiple components. The component v1 is only one component of the multiple components. Other components of the multiple components except the component v1 can be synthesized into component v2.

In some embodiments, when the flight controller detects that the velocity vector V includes the component v1 pointing to the flight restriction zone, the component v1 of the velocity vector V may be removed and other components other than the component v1 such as the component v2 are kept. The UAV is controlled to fly according to the component after removing the component v1, for example, the UAV is controlled to fly according to the component v2. As shown in FIG. 4, when the flight controller controls the UAV according to the component v2, the UAV 20 flies along the boundary of the flight restriction zone without entering the flight restriction zone.

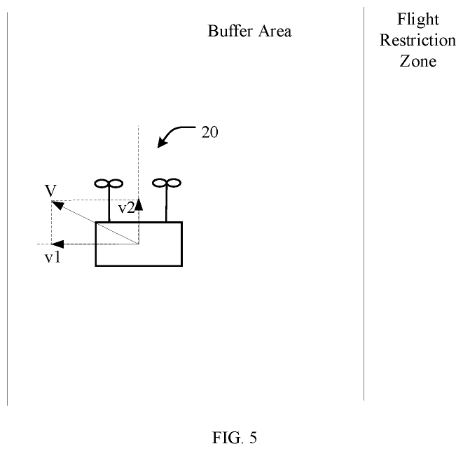

In some other embodiments, the velocity vector indicated by the joystick value sent by the ground terminal 21 to the UAV 20 may also point against the flight restriction zone. As shown in FIG. 5, the component v1 of the velocity vector V points against the flight restriction zone. At this time, the flight controller 22 can execute the joystick value. When the flight controller 22 controls the UAV 20 to fly according to the velocity vector V shown in FIG. 5, the UAV 20 flies away from the flight restriction zone.

In addition, what shown in FIGS. 3-5 are only schematic. The magnitude and direction of the velocity vector V are not limited thereto.

At S104, the velocity of the UAV is controlled according to the location information of the flight restriction zone.

The flight controller 22 can also control the velocity of the UAV 20 according to the location information of the flight restriction zone, for example, when the flight controller 22 determines the buffer area of the flight restriction zone based on the location information of the flight restriction zone and determines the UAV 20 has entered the buffer area, the velocity of the UAV 20 can be controlled to slow down the UAV 20, or the UAV 20 can be controlled to hover.

In some embodiments, the location information of the UAV and the location information of the flight restriction zone are obtained, and the current non-velocity-control mode of the UAV is switched to the velocity-control mode when it is determined that the UAV enters the buffer area of the flight restriction zone according to the location information of the UAV and the location information of the flight restriction zone. Therefore, the UAV can fly in the velocity-control mode and the velocity of the UAV can be effectively controlled to prevent the UAV from flying at a higher velocity in the non-velocity-control mode into the flight restriction zone, thereby reducing the probability of the UAV entering the flight restriction zone.

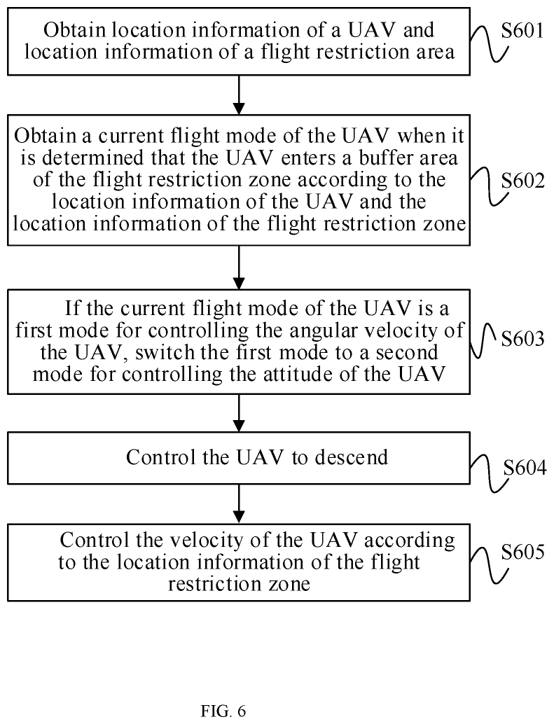

A control method for a UAV is provided according to an embodiment of the present disclosure. FIG. 6 is a flow chart of the control method for the UAV according to another embodiment of the present disclosure. As shown in FIG. 6, at S601, location information of the UAV and location information of a flight restriction area are obtained.

The specific principle and implementation of S601 are similar to those of S101 and are not repeated here.

At S602, when it is determined that the UAV enters a buffer area of the flight restriction zone according to the location information of the UAV and the location information of the flight restriction zone, a current flight mode of the UAV is obtained.

The specific principle and implementation of S602 are similar to those of S102 and are not repeated here.

At S603, if the current flight mode of the UAV is a first mode for controlling the angular velocity of the UAV, the first mode is switched to a second mode for controlling the attitude of the UAV.

In some embodiments, if the current flight mode of the UAV 20 is the first mode such as a manual mode, the flight controller 22 may also switch the current first mode of the UAV 20 such as the manual mode to the second mode such as the attitude mode to make the UAV 20 fly in the attitude mode.

At S604, the UAV is controlled to descend.

Specifically, after the flight controller 22 switches the current first mode of the UAV 20, such as the manual mode, to the second mode, such as the attitude mode, the flight controller 22 may control the UAV 20 to descend. Thus, the UAV 20 is prevented from entering the flight restriction zone. That is, the UAV directly descends when it flies into the buffer area. As long as the buffer area is wide enough, the UAV will descend in the buffer area of the flight restriction zone.

At S605, the velocity of the UAV is controlled according to the location information of the flight restriction zone.

The specific principle and implementation of S605 are similar to those of S104 and are not repeated here.

In some embodiments, when the UAV enters the buffer area of the flight restriction zone, the current first mode of the UAV, such as the manual mode, is switched to the second mode, such as the attitude mode. In the attitude mode, the UAV is controlled to descend to make the UAV descend directly upon entering the buffer area. As long as the buffer area is wide enough, the UAV will descend in the buffer area of the flight restriction zone, thereby greatly reducing the probability of the UAV entering the flight restriction zone.

A control method for a UAV is provided according to embodiments of the present disclosure. Based on the above embodiments, the method in some embodiments may further include adjusting the buffer area of the flight restriction zone according to the current flight mode of the UAV.

Under normal circumstances, the flying velocity of the UAV in the manual mode or the attitude mode is relatively fast, so the UAV 20 may still fly through the buffer area and enter the flight restriction zone after the flight controller 22 switches the manual mode or the attitude mode of the UAV to the position mode. In order to solve this problem, in some embodiments, the size of the buffer area of the flight restriction zone may be adjusted according to the current flight mode of the UAV.

Adjusting the buffer area of the flight restriction zone according to the current flight mode of the UAV includes determining the minimum value of the buffer area size of the flight restriction zone according to the maximum velocity of the UAV in the current flight mode and the braking time of the UAV in the velocity-control mode.

For example, the current flight mode of the UAV is the manual mode, the maximum velocity of the UAV in the manual mode is 20 m/s, the maximum acceleration of the brake is 10 m/s², and the braking time of the UAV in the position mode is 2 s. It can be determined that the minimum width of the buffer area of the flight restriction zone is 40 m according to the maximum velocity of the UAV in the manual mode is 20 m/s and the braking time is 2 s. That is to say, if the current flight mode of the UAV is the manual mode, the width of the buffer area of the flight restriction zone should not be less than 40 m, otherwise the UAV will enter the flight restriction zone.

After determining the minimum value of the buffer area of the flight restriction zone, the method further includes determining the buffer area of the flight restriction zone according to the minimum value of the buffer area of the flight restriction zone and the size of a preset buffer area.

In order to reduce the probability of the UAV entering the flight restriction zone, when the minimum value of the buffer area of the flight restriction zone is determined, the size of the preset buffer area can also be added to the minimum value. For example, the minimum width of the buffer area is 40 m, and the width of the preset buffer area, such as 20 meters, is added thereto, resulting in a buffer area with a width of 60 meters.

In addition, the UAV can also send a prompt message to its corresponding ground terminal during the flight. There are multiple possible scenarios as follows.

One possible scenario is that when the UAV flies out of the buffer area of the flight restriction zone in the velocity-control mode, a prompt message is sent to the ground terminal corresponding to the UAV to remind the user that the UAV has flown out of the buffer area of the flight restriction zone.

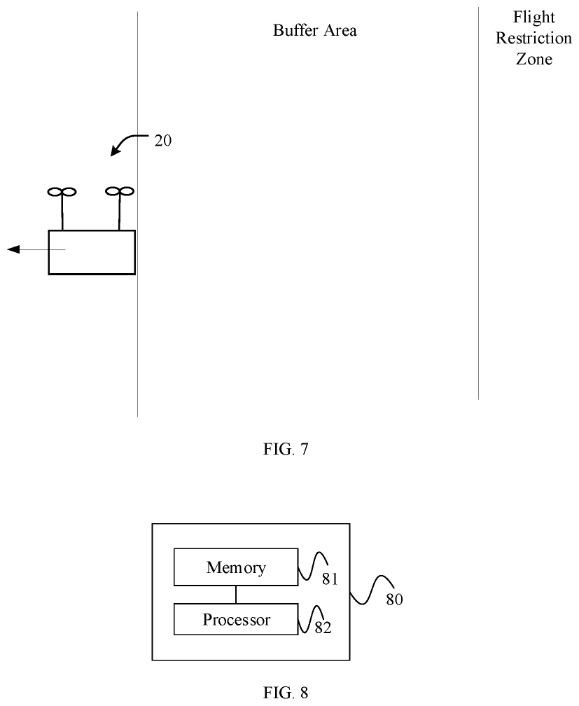

For example, the UAV 20 flies into the buffer area of the flight restriction zone in manual mode. After entering the buffer area, the flight controller 22 switches the manual mode of the UAV 20 to the position mode, so that the UAV 20 flies in the buffer area in the position mode. When the UAV 20 flies out of the buffer area of the flight restriction zone in the position mode, as shown in FIG. 7, the flight controller 22 may send a prompt message to the ground terminal 21 through the communication system 23 to remind the user that the UAV 20 has flown out of the buffer area. At this moment, the user may switch the position mode of the UAV 20 back to the manual mode according to the prompt message or may not switch the position mode of the UAV 20 back to the manual mode. That is, the UAV 20 still maintains the position mode when flying out of the buffer area or after flying out of the buffer area. If the user needs to switch the position mode of the UAV 20 back to the manual mode, the user can manually switch the mode switch back to the position mode, and then switch to the manual mode again. Because the manual mode of the UAV is more dangerous and difficult to operate, it is not suitable for the active switch of the UAV.

Another possible scenario is that when the UAV flies out of the buffer area of the flight restriction zone in the velocity-control mode, a prompt message is sent to the ground terminal corresponding to the UAV to remind the user that the velocity-control mode is switched back to the non-velocity-control mode.

For example, the UAV 20 flies into the buffer area of the flight restriction zone in manual mode. After entering the buffer area, the flight controller 22 switches the manual mode of the UAV 20 to the position mode, so that the UAV 20 flies in the buffer area in the position mode. When the UAV 20 flies out of the buffer area of the flight restriction zone in the position mode, as shown in FIG. 7, the flight controller 22 may send a prompt message to the ground terminal 21 through the communication system 23. The prompt message may remind the user to switch the position mode back to the manual mode. In other embodiments, the prompt message may also remind the user about the specific switching methods and steps.

Another possible scenario is that when the UAV enters the buffer area of the flight restriction zone, a prompt message is sent to the ground terminal corresponding to the UAV to remind the user that the UAV enters the buffer area of the flight restriction zone.

For example, when the flight controller 22 determines that the UAV 20 enters the buffer area of the flight restriction zone according to the location information of the UAV 20 and the location information of the flight restriction zone, the flight controller 22 can send a prompt message to the ground terminal 21 through the communication system 23. The prompt message is used to remind the user that the UAV has entered the buffer area of the flight restriction zone. When the UAV is in the buffer area, the flight controller 22 can continuously send prompt messages to the ground terminal 21, and when the UAV flies out of the buffer area, the flight controller 22 may stop sending the prompt message to the ground terminal 21, so that the user can determine that the UAV has flown out of the buffer area.

In other embodiments, the UAV may not send a prompt message to its corresponding ground terminal. Specifically, when the UAV flies out of the buffer area of the flight restriction zone in the velocity-control mode, the UAV is controlled to continue flying in the velocity-control mode.

For example, as shown in FIG. 7, when the UAV 20 flies out of the buffer area of the flight restriction zone in the position mode, the flight controller 22 can control the UAV to continue flying in the position mode without sending prompt messages to the ground terminal 21.

In some embodiments, with the buffer area of the flight restriction zone being adjusted according to the current flight mode of the UAV, the size of the buffer area can be dynamically adjusted according to the current flight mode of the UAV to ensure that the buffer area is wide enough to further reduce the probability of the UAV entering the flight restriction zone. In addition, when the UAV flies out of the buffer area, a prompt message is sent to the ground terminal. The prompt message may remind the user to switch the velocity-control mode of the UAV back to the non-velocity-control mode, or may instruct the user that the UAV has flown out of the buffer area and the user can decide whether to switch the velocity-control mode of the UAV back to the non-velocity-control mode. Because the manual mode of the UAV is more dangerous and difficult to operate, it is not suitable for the active switch of the UAV. The user can manually switch the position mode of the UAV back to the manual mode to improve the safety of the UAV and reduce the difficulty of the active switch of the UAV.

A flight controller is provided according to the embodiment of the present disclosure. FIG. 8 is a structural diagram of the flight controller according to an embodiment of the present disclosure. As shown in FIG. 8, the flight controller 80 includes a memory 81 and a processor 82. The memory 81 is used to store the programs and the processor 82 calls the programs. When the program is executed, causes the processor 82 to perform a method consistent with the disclosure, such as one of the example methods described above. For example, the program can cause the processor 82 to perform obtaining location information of the UAV and location information of the flight restriction zone, obtaining the current flight mode of the UAV when it is determined that the UAV enters the buffer area of the flight restriction zone according to the location information of the UAV and the location information of the flight restriction zone, switching the non-velocity-control mode to the velocity-control mode to make the UAV fly in the velocity-control mode if the current flight mode of the UAV is non-velocity-control mode, and controlling the velocity of the UAV according to the location information of the flight restriction zone.

In some embodiments, the non-velocity-control mode includes at least one of a first mode for controlling the angular velocity of the UAV and a second mode for controlling the attitude of the UAV.

In some embodiments, the velocity-control mode includes a third mode for controlling the velocity of the UAV.

In some embodiments, after the processor 82 switches the non-velocity-control mode to the velocity-control mode, it can be further configured to obtain a control command for controlling the UAV and not to execute the control command if the components of the control vector indicated by the control command include a component pointing to the flight restriction zone.

In some embodiments, after the processor 82 switches the non-velocity-control mode to the velocity-control mode, it can be further configured to obtain a control command for controlling the UAV, remove the component pointing to the flight restriction zone from the components of the control vector if the components of the control vector indicated by the control command include a component pointing to the flight restriction zone, and control the UAV to fly according to the control command after removing the component pointing to the flight restriction zone.

In some embodiments, the processor 82 is further configured to control the UAV to hover when it is determined that the UAV enters the buffer area of the flight restriction zone.

In some embodiments, the processor 82 is further configured to switch the first mode for controlling the angular velocity of the UAV to the second mode for controlling the attitude of the UAV if the current flight mode of the UAV is the first mode.

In some embodiments, after the processor 82 switches the first mode to the second mode for controlling the attitude of the UAV, it is further configured to control the UAV to descend.

In some embodiments, the processor 82 is further configured to adjust the buffer area of the flight restriction area according to the current flight mode of the UAV.

In some embodiments, when the processor 82 adjusts the buffer area of the flight restriction zone according to the current flight mode of the UAV, it is specifically configured to determine the minimum value of the size of the buffer area of the flight restriction zone according to the maximum velocity of the UAV in the current flight mode and the braking time of the UAV in the velocity-control mode.

In some embodiments, after the processor 82 determines the minimum value of the size of the buffer area of the flight restriction zone, it is further configured to determine the buffer area of the flight restriction zone according to the minimum value of the size of the buffer area of the flight restriction zone and the size of the preset buffer area.

In some embodiments, the processor 82 is further configured to control the UAV to descend when it is determined that the UAV enters the flight restriction zone based on the location information of the UAV.

In some embodiments, the processor 82 is further configured to send a prompt message to the ground terminal corresponding to the UAV through the communication system of the UAV when the UAV flies out of the buffer area of the flight restriction zone in the velocity-control mode. The prompt message reminds the user that the UAV has flown out of the buffer area of the flight restriction zone.

In some embodiments, the processor 82 is further configured to send a prompt message to the ground terminal corresponding to the UAV through the communication system of the UAV when the UAV flies out of the buffer area of the flight restriction zone in the velocity-control mode. The prompt message reminds the user to switch the velocity-control mode back to the non-velocity-control mode.

In some embodiments, the processor 82 is further configured to send a prompt message to the ground terminal corresponding to the UAV through the communication system of the UAV when the UAV enters the buffer area of the flight restriction zone to remind the user that the UAV enters the buffer area of the flight restriction zone.

In some embodiments, the processor 82 is further configured to control the UAV to continue flying in the velocity-control mode when the UAV flies out of the buffer area of the flight restriction zone in the velocity-control mode.

The specific principles and implementations of the flight controller provided by the embodiments of the present disclosure are similar to the embodiments shown in FIGS. 1 and 6 and are not repeated here.

In some embodiments, the location information of the UAV and the location information of the flight restriction zone are obtained, and the current non-velocity-control mode of the UAV is switched to the velocity-control mode when it is determined that the UAV enters the buffer area of the flight restriction zone according to the location information of the UAV and the location information of the flight restriction zone. Therefore, the UAV can fly in the velocity-control mode and the velocity of the UAV can be effectively controlled to prevent the UAV from flying at a higher velocity in the non-velocity-control mode into the flight restriction zone, thereby reducing the probability of the UAV entering the flight restriction zone.

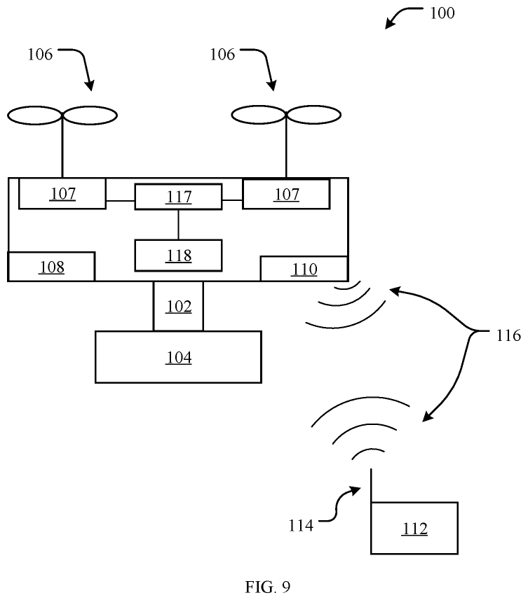

A UAV is provided according to an embodiment of the present disclosure. FIG. 9 shows a structural diagram of the UAV consistent with the present disclosure. As shown in FIG. 9, the UAV 100 includes a vehicle body, a power system, and a flight controller 118. The power system includes at least one of a motor 107, a propeller 106, or an electronic governor 117. The power system is installed at the vehicle body to provide power for flight. The flight controller 118 communicates with the power system to control the flight of the UAV.

The specific principles and implementation of the flight controller 118 are similar to the flight controller described in the above embodiments and are not repeated here.

In addition, as shown in FIG. 9, the UAV 100 further includes a sensor system 108, a communication system 110, a support device 102, and a photographing device 104. The support device 102 may specifically be a gimbal, and the communication system 110 may include a receiver. The receiver is used to receive the wireless signal transmitted by the antenna 114 of the ground station 112, and 116 represents the electromagnetic wave generated during the communication between the receiver and the antenna 114.

In some embodiments, the location information of the UAV and the location information of the flight restriction zone are obtained, and the current non-velocity-control mode of the UAV is switched to the velocity-control mode when it is determined that the UAV enters the buffer area of the flight restriction zone according to the location information of the UAV and the location information of the flight restriction zone. Therefore, the UAV can fly in the velocity-control mode and the velocity of the UAV can be effectively controlled to prevent the UAV from flying at a higher velocity in the non-velocity-control mode into the flight restriction zone, thereby reducing the probability of the UAV entering the flight restriction zone.

In the embodiments of the present disclosure, the disclosed devices and methods may be implemented in other ways. For example, the embodiments of the device described above are only schematic. For example, the division of the units is only a division of logical functions. In actual implementation, there may be other dividing methods. For example, multiple units or components may be combined or integrated into another system, or some features can be ignored or not implemented. In addition, the shown or discussed coupling, direct coupling or communication connection may be through some interfaces. The indirect coupling or communication connection may be in electrical, mechanical or other forms.

The units described as separate components may or may not be physically separated, and the components shown as units may or may not be physical units, that is, they may be located in one place, or may be distributed on multiple units in a network. Some or all of the units may be selected according to actual needs to implement the embodiments.

In addition, the functional units in the various embodiments of the present disclosure may be integrated in one processing unit, or each unit may be an individual physically unit, or two or more units may be integrated in one unit. The above integrated unit can be implemented in the form of hardware or implemented in form of hardware plus software.

The above integrated unit implemented in the form of a software functional unit may be stored in a computer-readable storage medium. The above software functional unit is stored in a storage medium, and includes several instructions to enable a computer device (which may be a personal computer, a server, or a network device, etc.) or a processor to execute the methods described in the embodiments. The storage medium mentioned above can be a U disk, a portable hard disk, a read-only memory (ROM), a random-access memory (RAM), a magnetic disk or an optical disk and any other media that can store programs.

Those skilled in the art can clearly understand that, for the convenience and conciseness of description, only the foregoing division of each functional module is used as an example for illustration. In practical applications, the foregoing functions can be performed by different functional modules according to needs, that is, the internal structure of the device can be divided into different functional modules to perform all or part of the functions described above. For the specific working process of the device described above, reference may be made to the corresponding process in the foregoing embodiments, and details are not described herein again.

Finally, it should be noted that the above embodiments are only used to illustrate the technical solution of the present disclosure, rather than to limit it. Although the present disclosure has been described in detail with reference to the foregoing embodiments, those of ordinary skill in the art should understand that the technical solutions described in the foregoing embodiments can still be modified and some or all of the technical features can be equivalently replaced. These modifications or replacements do not make the essence of their corresponding technical solutions deviate from the technical solutions of the embodiments of the present disclosure.

What is claimed is:

1. A control method for an unmanned aerial vehicle (UAV) comprising:
obtaining location information of the UAV and location information of a flight restriction area;
obtaining a flight mode of the UAV in response to determining that the UAV enters a buffer area of the flight restriction zone according to the location information of the UAV and the location information of the flight restriction zone;
in response to the flight mode of the UAV being a non-velocity-control mode, switching the flight mode of the UAV from the non-velocity-control mode to a velocity-control mode; and
controlling a velocity of the UAV according to the location information of the flight restriction zone.

2. The method of claim 1, wherein the non-velocity-control mode includes at least one of:
a first mode for controlling an angular velocity of the UAV; or
a second mode for controlling an attitude of the UAV.

3. The method of claim 1, wherein the velocity-control mode includes a mode for controlling the velocity of the UAV.

4. The method of claim 1, further comprising, after switching to the velocity-control mode:
obtaining a control command for controlling the UAV; and
determining to not execute the control command in response to a component of a control vector indicated by the control command pointing to the flight restriction zone.

5. The method of claim 1, further comprising, after switching to the velocity-control mode:
obtaining a control command for controlling the UAV; and
in response to determining a component of a control vector indicated by the control command pointing to the flight restriction zone:
removing the component pointing to the flight restriction zone from the control vector; and
controlling the UAV to fly according to the control command with the component pointing to the flight restriction zone being removed.

6. The method of claim 1, further comprising:
controlling the UAV to hover in response to determining that the UAV enters the buffer area of the flight restriction zone.

7. The method of claim 1, further comprising:
in response to determining that the flight mode of the UAV is a first mode for controlling an angular velocity of the UAV, switching the flight mode from the first mode to a second mode for controlling an attitude of the UAV.

8. The method of claim 7, further comprising, after switching to the second mode:
controlling the UAV to descend.

9. The method of claim 1, further comprising:
adjusting the buffer area of the flight restriction zone according to the flight mode of the UAV.

10. The method of claim 9, wherein adjusting the buffer area includes determining a minimum buffer area size of the flight restriction zone according to a maximum velocity of the UAV in the flight mode and a braking time of the UAV in the velocity-control mode.

11. The method of claim 10, wherein adjusting the buffer area further includes, after determining the minimum buffer area size:
determining the buffer area according to the minimum buffer area size and a preset buffer area size.

12. The method of claim 1, further comprising:
controlling the UAV to descend in response to determining that the UAV enters the flight restriction zone based on the location information of the UAV.

13. The method of claim 1, further comprising:
in response to the UAV flying out of the buffer area in the velocity-control mode, sending a prompt message to a ground terminal corresponding to the UAV to prompt user that the UAV has flown out of the buffer area.

14. The method of claim 1, further comprising:
in response to the UAV flying out of the buffer area of the flight restriction zone in the velocity-control mode, sending a prompt message to a ground terminal corresponding to the UAV to prompt a user to switch back to the non-velocity-control mode.

15. The method of claim 1, further comprising:
in response to the UAV entering the buffer area, sending a prompt message to a ground terminal corresponding to the UAV to prompt a user that the UAV enters the buffer area.

16. The method of claim 1, further comprising:
in response to the UAV flying out of the buffer area in the velocity-control mode, controlling the UAV to continue flying in the velocity-control mode.

17. A flight controller of an unmanned aerial vehicle (UAV) comprising:
a memory storing a program; and
a processor configured to execute the program to:
obtain location information of the UAV and location information of a flight restriction area;
obtain a flight mode of the UAV in response to determining that the UAV enters a buffer area of the flight restriction zone according to the location information of the UAV and the location information of the flight restriction zone;
in response to the flight mode of the UAV being a non-velocity-control mode, switch the flight mode of the UAV from the non-velocity-control mode to a velocity-control mode; and
control a velocity of the UAV according to the location information of the flight restriction zone.

18. The flight controller of claim 17, wherein the non-velocity-control mode includes at least one of:
a first mode for controlling an angular velocity of the UAV; or
a second mode for controlling an attitude of the UAV.

19. The flight controller of claim 17, wherein the velocity-control mode includes a mode for controlling the velocity of the UAV.

20. The flight controller of claim 17, wherein the processor is further configured to execute the program to, after switching to the velocity-control mode:
obtain a control command for controlling the UAV; and
determine to not execute the control command in response to a component of a control vector indicated by the control command pointing to the flight restriction zone.
